(19) United States
(12) Patent Application Publication
(10) Pub. No.: US 2017/0061155 A1
(43) Pub. Date: Mar. 2, 2017

(54) Selective Policy Based Content Element Obfuscation

(71) Applicant: International Business Machines Corporation, Armonk, NY (US)

(72) Inventors: Itai Gordon, Jerusalem (IL); Peter Hagelund, Copenhagen (DK); David J. Henderson, Newtown, PA (US)

(21) Appl. No.: 14/840,444

(22) Filed: Aug. 31, 2015

(51) Int. Cl. G06F 21/62

(52) U.S. Cl. CPC G06F 21/6254

(57) ABSTRACT

Mechanisms are provided that implement a policy based content masking engine. The mechanisms obtain electronic content comprising instances of identifiable elements of different types capable of uniquely identifying a person and retrieve a policy in response to obtaining the electronic content. The policy specifies a set of identifiable elements of different types to be masked in the electronic content. The mechanisms modify, responsive to the retrieved policy, the electronic content to mask instances of the set of identifiable elements in the electronic content. Modifying the electronic content includes applying different masking actions to the different types of identifiable elements in the set of identifiable elements. The mechanisms also output the modified electronic content which includes obscured or replaced instances of the identifiable elements in the set of identifiable elements.

### BACKGROUND

The present application relates generally to an improved data processing apparatus and method and more specifically to mechanisms for performing selective policy based content element obfuscation.

Anonymization of data is an important consideration in today's computer oriented society where individual privacy may be relatively easily circumvented using computerized mechanisms. That is, through websites, databases, directories, and the like, personal information for individuals is collected and made accessible for legitimate uses, but can also be exploited for illegitimate uses. Individual privacy is becoming a more important issue as identity theft and other illegal access to personal information becomes more rampant. Furthermore, governmental regulations require that certain types of data about individuals, such as medical history information, be kept secure.

Known anonymization systems and techniques essentially utilize a pattern matching or keyword search to identify standardized pieces of information to obfuscate or eliminate from being able to be returned as results of a query. In more structured systems, a type of field basis may be used for identifying fields containing personally identifiable information. In general, these systems identify fields in data, such as names, addresses, zip codes, etc., that are determined to be fields that may be used to individually identify a particular person, and programmatically obfuscate or eliminate these fields from being able to be returned as results of a query.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided, in a data processing system comprising a processor and a memory, the memory comprising instructions which, when executed by the processor, cause the processor to implement a policy based content masking engine. The method comprises obtaining, by the policy based content masking engine, electronic content comprising instances of identifiable elements of different types capable of uniquely identifying a person. The method further comprises retrieving, by the policy based content masking engine, a policy in response to obtaining the electronic content. The policy specifies a set of identifiable elements of different types to be masked in the electronic content. Moreover, the method comprises modifying, by the policy based content masking engine, responsive to the retrieved policy, the electronic content to mask instances of the set of identifiable elements in the electronic content. Modifying the electronic content comprises applying different masking actions to the different types of identifiable elements in the set of identifiable elements. Furthermore, the method comprises outputting, by the policy based content masking engine, the modified electronic content, wherein the modified electronic content comprises obscured or replaced instances of the identifiable elements in the set of identifiable elements.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 is an example block diagram of a policy based content obfuscation or masking engine in accordance with one illustrative embodiment;

FIG. 4A is an example diagram of a digital image prior to masking by the mechanisms of the illustrative embodiments;

FIG. 4B is an example diagram of a digital image after application of a policy based masking operation in accordance with one illustrative embodiment; and

FIG. 5 is a flowchart outlining an example operation for performing policy based masking in accordance with one illustrative embodiment.

### DETAILED DESCRIPTION

It should be appreciated that anonymization, obfuscating, masking, or the like, of personally identifiable information (PII), also referred to as sensitive personal information (SPI), is also of increasing importance with digital images. That is, as digital imaging technology increases, and the ability to perform image analysis to extract information is becoming more advanced, it is important to ensure that portions of the digital images having PII or SPI are likewise maintained secure through anonymization, obfuscating, masking or the like. Various laws, regulations, and company or organization rules may be established to ensure such PII or SPI in digital images are removed, masked, replaced, or otherwise obfuscated before storing or otherwise disseminating the digital image data within, or outside, the particular organization.

Mechanisms have been provided for obfuscating or masking individual specific elements of a digital image. For example, U.S. Pat. No. 8,270,718, entitled “Manipulating an Image by Applying a De-Identification Process” describes a mechanism for changing text in images for de-identification. International Patent Application Publication WO 2013136093, entitled “Image Data Storage and Sharing,” describes a mechanism for finding and obscuring identifying text from medical images. The article Newton et al., “Preserving Privacy by De-Identifying Facial Images,” Carnegie Mellon University, School of Computer Science, March 2003, is one example document describing a mechanism for obscuring facial images in digital image data.

It should be appreciated that while each of these documents describe different mechanisms for obscuring text and facial images, respectively, each are limited to a single type of obfuscation or masking of identifiable information. It should further be noted that many times, digital image data may comprise multiple different types of identifiable information, such that a single technique for obfuscation or masking will likely fail to obscure or mask all of the identifiable information in a digital image. Moreover, depending on the particular organization handling the digital image data, different portions of identifiable information within the digital image data may need to be obscured, masked, or otherwise obfuscated while other organizations may require a different set of identifiable information within the digital image data to be obscured, masked, or otherwise obfuscated, or obscured, masked, or obfuscated in a different manner. For purposes of the following description, the term “masked” will be used to generally cover any type of masking, obfuscation, replacement, obscuring, anonymization, removal, or otherwise make unidentifiable the identifiable information in a digital image.

For example, assume that an insurance company needs to send, as part of an accident report, an image of an automobile accident to an outsourcing investigator in order to determine which automobile caused the accident in question. A company policy may be established that indicates that no identifiable elements should be included in the digital image data sent outside the company computer systems. In this scenario, the digital image may comprise images of persons present at the accident site with their faces viewable, automobiles involved in the accident and/or in the vicinity of the accident with exposed license plate numbers and models of the automobiles clearly identifiable, and images of houses or businesses in the background. Applying a single technique for masking identifiable elements in the digital image will only mask a subset of the identifiable elements within the digital image, e.g., facial data, but will leave a number of other identifiable elements within the digital image, e.g., license plate numbers, make/model of the automobiles, house numbers, business names, etc. Moreover, different computing systems handling the digital image data may desire to apply different types of masking of identifiable information.

The illustrative embodiments provide mechanisms for performing selective policy based content element obfuscation or masking. In particular, the content may comprise text and images with elements in both the text and images being able to be masked based on established masking policies. Moreover, different types of elements within the digital images may be masked based on the selected policies.

With the mechanisms of the illustrative embodiments, content is received that includes a digital image. The digital image includes personally identifiable information (PII) or Sensitive Personal Information (SPI) elements (referred to herein as “identifiable elements”) in the digital image, which may be of a single or various types, e.g., textual type, facial image type, etc. The content is analyzed to identify one or more characteristics of the content which may include a context of the content, e.g., the content is an accident report, the content is part of a medical file, the content is part of an insurance claim, etc. Based on the characteristics of the content, one or more masking policies are retrieved that identify what identifiable elements in the content are to be masked, what models or algorithms to use to identify the identifiable elements, what algorithms to use to mask the identifiable elements, what replacement images to utilize when masking the identifiable elements, or the like. The retrieved one or more masking policies are applied to select the models/algorithms for identification of the identifiable elements, masking the identifiable elements, and the like. Again, this may mask different types of identifiable elements within the same digital image such that all identifiable elements of interest of various types are masked according to the one or more masking policies. The resulting masked digital image may then be stored and/or output for the specific desired use while maintaining the security of the identifiable elements of the original digital image and the coherency of the visual representation of the other elements in the digital image.

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

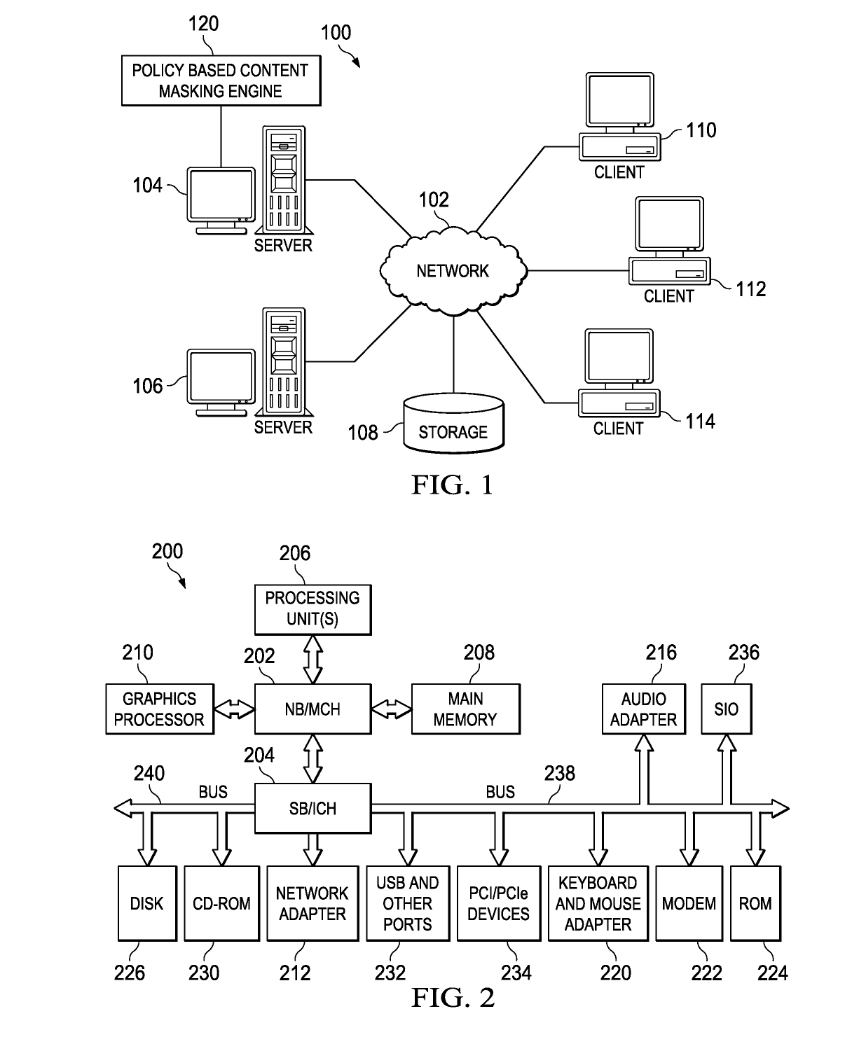

The illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

As shown in FIG. 1, one or more of the computing devices, e.g., server 104, may be specifically configured to implement a selective policy based content obfuscating mechanism. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates selective policy based content obfuscation or masking that accommodates the obfuscating or masking of different types of identifiable elements in both text and images in accordance with the selected sub-set of elements that should be masked as specified by the selective policy.

That is, as shown in FIG. 1, one or more of the servers 104, 106 and/or client computing devices 110, 112, or 114 may be configured to implement a policy based content masking engine 120. In the depicted example, the server 104 is configured to include the necessary logic for implementing such a policy based content masking engine 120 in accordance with one or more of the illustrative embodiments described herein. In one illustrative embodiment, the server 104 receives content from one or more users of client devices 110, 112, or 114 which may then be accessible by other users and/or disseminated to other users via the network 102. In making such content accessible by, or otherwise transmitting the content to, other users, the server 104 may be configured to mask certain elements of the content in accordance with established masking policies. The particular masking policies may be tied to the characteristics of the content in which the identifiable elements are present and/or the intended use and/or users to which the content is to be transmitted or who are attempting to access the content. The policy based content masking engine 120 determines the characteristics of the content and applies one or more policies based on the characteristics of the content to the content to identify elements that are to be masked and applies corresponding masking algorithms, replacement elements, and the like, to mask the various elements specified in the one or more policies. Moreover, such identification of policies may be further keyed to characteristics of requests from other users to access the content, requests to disseminate the content, or the like so as to perform different types of masking of elements of the content based on the particular type of use of the content and/or the particular users to which the content is being provided.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCl/PCIe devices 234 connect to SB/ICH 204 through bus 238 and bus 240. PCl/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System p® computer system, Power™ processor based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

As mentioned above, in some illustrative embodiments the mechanisms of the illustrative embodiments may be implemented as application specific hardware, firmware, or the like, application software stored in a storage device, such as HDD 226 and loaded into memory, such as main memory 208, for executed by one or more hardware processors, such as processing unit 206, or the like. As such, the computing device shown in FIG. 2 becomes specifically configured to implement the mechanisms of the illustrative embodiments and specifically configured to perform the operations and generate the outputs described hereafter with regard to the policy based content obfuscation or masking engine.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

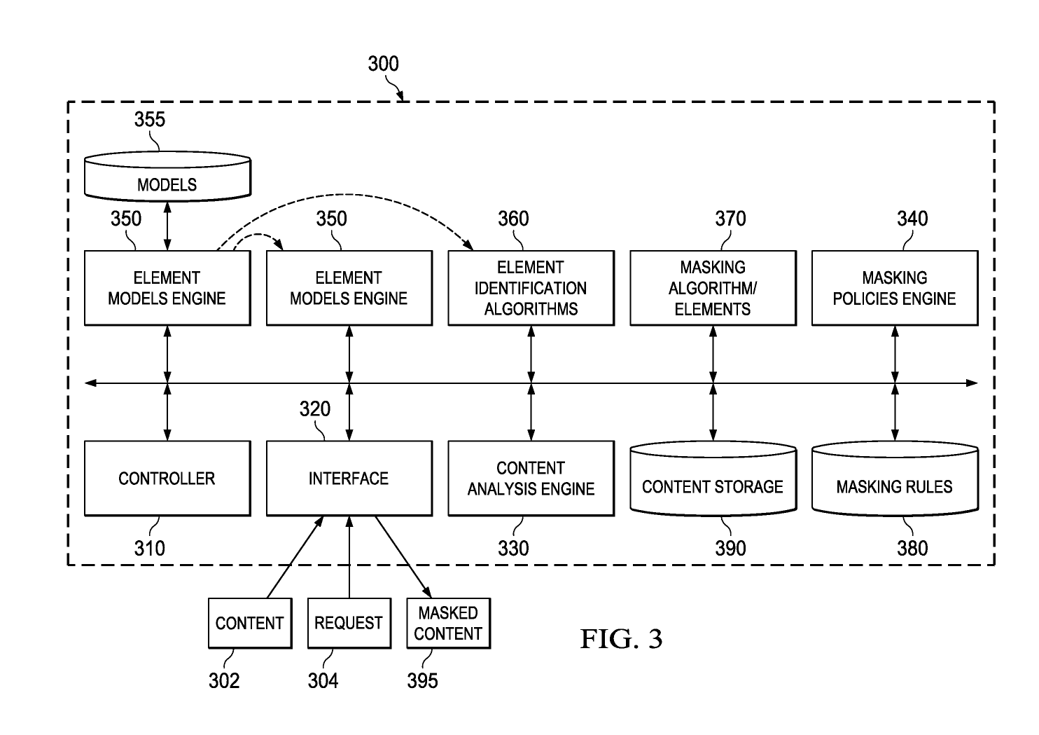

FIG. 3 is an example block diagram of a policy based content obfuscation or masking engine in accordance with one illustrative embodiment. The operational elements shown in FIG. 3 may be implemented in logic, provided as executed software instructions, hardware logic, or a combination of executed software instructions and hardware logic, which perform the particular functions and actions described herein as associated with the particular elements. In some illustrative embodiments, the policy based content obfuscation or masking engine is the policy based content masking engine 120 in FIG. 1.

As shown in FIG. 3, the policy based content masking engine 300 comprises a controller 310, an interface 320, a content analysis engine 330, a masking policies engine 340, an element models engine 350, element identification algorithms repository 360, a masking algorithm/elements repository 370, masking rules repository 380, and content storage 390. The controller 310 controls the overall operation of policy based content masking engine 300 and orchestrates the operation and accessing of the other elements 320-390 of the policy based content masking engine 300. The interface 320 provides a communication pathway through which content and requests may be passed to and from the policy based content masking engine 300. The interface 320 may facilitated data network communication with an external network to which the policy based content masking engine 300 is coupled.

The policy based content masking engine 300 may receive a portion of content 302 having one or more characteristics defining the type of content. The content 302 may comprise various types of elements including textual elements, image elements, audible elements, or the like. The one or more characteristics define the context in which these elements are provided. For example, the content may be an accident report from an insurance adjuster with the policy based content masking engine 300 being implemented as part of an insurance company's data processing system. The “accident report” is a characteristic of the content 302 that identifies the context in which the various elements are being provided as part of the content 302. Thus, for example, elements of text may be text descriptions of the accident, parties involved, observations made by an insurance adjuster, etc. Elements of images may represent elements present at the accident scene. Elements of audible portions of the content 302 may represent statements recorded from witnesses. The various characteristics provide information by which to interpret the types of elements and the content 302 as a whole.

The characteristics of the content 302 may be identified by an initial analysis of the content 302 performed by the content analysis engine 330. The characteristics extracted by the content analysis engine 330 may be provided to the masking policies engine 340 which identifies one or more pre-defined policies that are defined for the particular characteristics of the content 302. For example, in the insurance report example mentioned above, one or more policies may be pre-defined for automobile accident reports and by identifying a characteristic of the content 302 that indicates that the content 302 is an accident report or part of an accident report, the corresponding one or more policies are retrieved by the masking policies engine 340.

The policies that are defined, stored, and retrieved by the masking policies engine 340 may be defined using various masking rules in a masking rules repository 380. For example, masking rules may specify which particular identifiable elements in content are to be masked, when such identifiable elements are to be masked, and how these identifiable elements are to be masked. The policies combine one or more rules from the masking rules repository 380 along with triggering characteristics of content which are used to identify which policies apply to which types of content. The masking rules may state, for example, that when element A is part of an accident report, element A is to be masked, and element A is to be masked by replacing element A with a designated replacement element B or that a particular masking algorithm is to be applied to the portion of content data corresponding to element A. For example, a rule may specify that if a digital image, which is part of an accident report, includes a license plate number of a vehicle, the license plate number portion of the digital image is to be replaced with a replacement license plate number that is generic in nature in accordance with an established element model. Alternatively, an algorithm may be specified for masking the license plate number or the like. Various rules may be established for different combinations of element types, characteristics of the content, masking operations to be performed, and the like.

Multiple policies may be established for the same characteristics of received content and/or requests/users attempting access or to which content is to be transmitted. The particular policies corresponding to characteristics of the content received and/or the requests for access/user to which the content is to be transmitted, define a set of elements that are to be masked. The set of elements to be masked is provided to the element models engine 350 which retrieves corresponding element models for the elements in the set of elements to be masked. The element models stored by and maintained by the element models engine 350 map identifiable elements that are to be masked to particular ones of the element identification algorithms 360 and masking elements/algorithms 370. Thus, by identifying the set of elements by retrieving the policies corresponding to the characteristics of the content/request/user, the corresponding element models are identified which in turn maps to element identification algorithms for identifying the specified elements within the content 302 as well as the masking elements/algorithms that are to be used to mask the identified instances of the element within the content 302.

The element identification algorithms 360 provide patterns and analytical algorithms for analyzing the data of the content 302 and identifying portions of the content 302 that have elements matching the elements in the set of elements to be masked. For example, if the policies associated with the context of the content 302 indicate that facial feature portions of a digital image, license plate numbers of vehicles, and any text in the digital image are to be masked, then corresponding element models 350 are retrieved that identify the corresponding element identification algorithms and patterns 360 corresponding to these types of elements are retrieved and applied to the content 302 to identify portions of the content 302 having those elements. The masking elements/algorithms 370 for those particular element types, as indicated by the element models 350, are then applied to the identified portions of the content to thereby mask these portions of the content 302. It should be appreciated that the other portions of the content 302 not identified as an identifiable element that is to be masked, are not obscured and the visual representation of these other portions is maintained as a coherent view.

The resulting masked version of the content 302 may be stored in content storage 390 for later use, retrieval, accessing by users, or dissemination to other users via the interface 320. In addition, or alternatively, the masked content 395 may be output to an originator of the content 302, a user desiring access to the content, or a user to which the content is to be disseminated based on a request for dissemination of content 302.

It should be appreciated that in some illustrative embodiments, in addition to, or in replacement of, the analysis and masking of the content 302 in response to the content 302 being received, masking of elements of the content 302 may be performed in response to a request 304 to either access the content 302 or otherwise transmit the content 302 to another user. For example, the non-masked content 302 may be stored in the content storage 390 in a secure manner, e.g., encrypted or otherwise made inaccessible to non-authorized users. A request 304 may be received to access the content 302 stored in the content storage. The request 304 may specify the content 302 that is the target of the request, a requesting user identifier, a requested action, among other characteristics of the request 304. These request characteristics may be used to retrieve masking policies 340 corresponding to the particular combination of these request characteristics and the content characteristics to determine when, what, and how to mask the elements in the content 302. In this way, different elements and different types of masking may be applied to different elements, based on the type of content that is the target of the request, the particular user that is the source of the request, and the type of action that is being requested to be performed with regard to the content.

Based on the retrieved policies, a similar operation as described above may be applied to the content 302 retrieved from the content storage 390 to thereby generate masked content 395 which may be output to the requesting user or another user specified by the request 304, e.g., a request from an insurance adjuster of an insurance company to transmit a copy of an accident report to another party, such as a private investigator or the like.

Thus, the illustrative embodiments provide mechanism for using policies to specify the types of personally identifiable information (PII) and Sensitive Personal Information (SPI) elements in content, especially digital images, to be masked. The types of these identifiable elements may be varied with different types of identifiable elements being simultaneously present in a single portion of content, e.g., a single digital image. The illustrative embodiments, based on the context of the content, determine which policies to apply to the content, which in turn specifies which identifiable elements to mask. This information is mapped to identification algorithms that analyze the content to identify the elements to mask in the content and further is mapped to masking elements and/or algorithms for specifically masking the identified instances of the elements in the content.

Taking the previously mentioned example above, again assume that an insurance company needs to send, as part of an accident report, an image of an automobile accident to an outsourcing investigator in order to determine which automobile caused the accident in question. A company policy may be established, which corresponds to the context of an accident report, that indicates that no identifiable license plate number, facial feature, or background text elements should be included in the digital image data sent outside the company computer systems. In this scenario, the digital image may comprise images of persons present at the accident site with their faces viewable, automobiles involved in the accident and/or in the vicinity of the accident with exposed license plate numbers and models of the automobiles clearly identifiable, and images business signage in the background. As noted above, applying a single technique for masking identifiable elements in the digital image will only mask a subset of the identifiable elements within the digital image. However, with the illustrative embodiments, based on the company's policy, all license plate numbers, facial features, and business signage and other text in the background will be masked and will be masked in the particular way required by the policy and/or element models established for the particular identifiable elements. Thus, a more secure communication of content is made possible by reducing the likelihood that personally identifiable information is released to unintended parties. Moreover, the particular elements masked, the way in which they are masked, when they are masked, and the like, may be customized to the particular context of the content, the particular user requesting the access to the content, the type of access to the content, and the like.

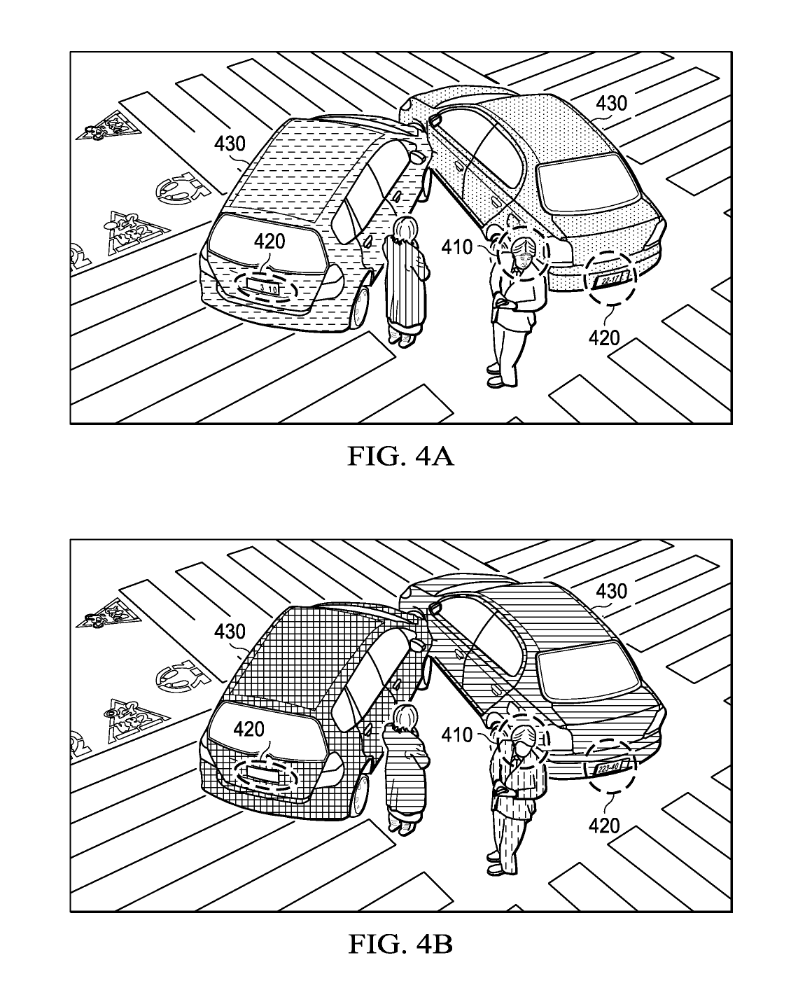

FIG. 4A is an example diagram of a digital image prior to masking by the mechanisms of the illustrative embodiments. The diagram shown in FIG. 4A is comprises a picture of an automobile accident which may be part of an accident report, for example. As can be seen from the example diagram, various personally identifiable elements are discernable within the diagram including facial features 410, license plate numbers of vehicles 420, make, model, and color of the vehicles involved 430, and the like. Thus, without obfuscating elements of the digital image, unauthorized individuals may be able to obtain personally identifiable information which may be useable to the detriment of the persons, businesses, or other entities identifiable in the digital image.

FIG. 4B is an example diagram of a digital image after application of a policy based masking operation in accordance with one illustrative embodiment. In the example diagram of FIG. 4B, it is assumed that a corresponding policy for an accident report is retrieved and applied in which the policy comprises rules for obfuscating license plate numbers, facial features, garment colors of persons, and the color of vehicles involved in an automobile accident. As a result, as shown in FIG. 4B, the facial features 410 are obscured through the application of a corresponding masking algorithm that blurs the image in the region of the facial features 410. Similarly, the license plate numbers 420 of the vehicles are either blurred or replaced with alternative license plate numbers. Furthermore, color filtration or other image processing algorithms are applied to the areas 430 of the image comprising the vehicles and the garments of the persons depicted so as to modify the coloring of these portions. Hence, while the context of the image is maintained, i.e. an image of an automobile accident, with information being maintained to ascertain information about the accident itself, the portions of the image that may be used to personally identify individuals or other entities is obscured.

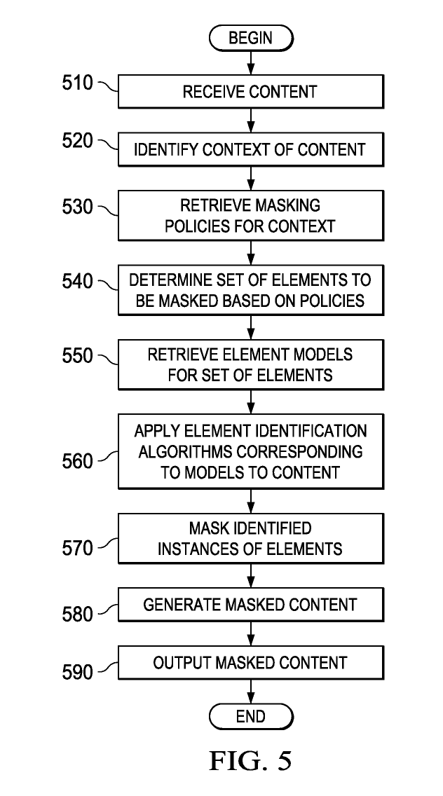

FIG. 5 is a flowchart outlining an example operation for performing policy based masking in accordance with one illustrative embodiment. The operation outlined in FIG. 5 may be implemented, for example, by a policy based content masking engine, such as engine 300 in FIG. 3, for example. It should be noted that while FIG. 5 is directed to an embodiment in which the masking is done in response to receiving content, in other illustrative embodiments, such masking may also, or alternatively, be performed in response to a request to access content by a particular user. In such other illustrative embodiments, characteristics of the user, the action being requested, and the content that is the target of the request may be used to determine the policies to be applied.

As shown in FIG. 5, the operation starts with the receipt of a portion of content which may include different types of identifiable elements (step 510). The content is analyzed to identify the context of the content (step 520). One or more masking policies associated with the context of the content are retrieved (step 530) and a corresponding set of elements to be masked is determined based on the retrieved policies (step 540). Element models corresponding to the set of elements to be masked are retrieved (step 550) and the corresponding element identification algorithms are applied to the content to identify instances of the elements in the content (step 560). Based on specifications in the retrieved policies and the masking algorithms/elements mapped to by the element model, the identified instances of the elements are masked by replacing or otherwise obfuscating the instances of the elements using the masking algorithms/elements (step 570). A masked content is generated based on the masked instances of elements and the other portions of the content that were not subject to masking (step 580). The masked content is then stored and/or output (step 590). The operation then terminates.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

1-10. (canceled)

11. A computer program product comprising a computer readable storage medium having a computer readable program stored therein, wherein the computer readable program, when executed on a computing device, causes the computing device to implement a policy based content masking engine that operates to:
obtain electronic content comprising instances of identifiable elements of different types capable of uniquely identifying a person;
retrieve a policy in response to obtaining the electronic content, wherein the policy specifies a set of identifiable elements of different types to be masked in the electronic content;
modify, responsive to the retrieved policy, the electronic content to mask instances of the set of identifiable elements in the electronic content, wherein modifying the electronic content comprises applying different masking actions to the different types of identifiable elements in the set of identifiable elements; and
output the modified electronic content, wherein the modified electronic content comprises obscured or replaced instances of the identifiable elements in the set of identifiable elements.

12. The computer program product of claim 11, wherein retrieving the policy further comprises:
determining at least one characteristic of the obtained electronic content;
identifying, in a policy data storage device, one or more stored policies associated with the determined at least one characteristic of the obtained electronic content; and
selecting the policy from the one or more stored policies, wherein a plurality of policies are stored in the policy data storage device for a plurality of different combinations of characteristics of electronic content.

13. The computer program product of claim 12, wherein the at least one characteristic of the obtained electronic content comprises a context of the obtained electronic content.

14. The computer program product of claim 11, further comprising:
receiving, by the policy based content masking engine, a request from a user to perform an action on the stored electronic content, wherein retrieving the policy further comprises:
determining at least one of a characteristic of the user or a characteristic of the action;
identifying the one or more stored policies based on at least one of the characteristic of the user or the characteristic of the action; and
selecting the policy from the one or more stored policies.

15. The computer program product of claim 11, wherein the instances of the set of identifiable elements are masked in the modified electronic content, and wherein other elements in the obtained electronic content are not masked in the modified electronic content.

16. The computer program product of claim 11, wherein the policy is a combination of a plurality of masking rules selected from a masking rules repository and corresponding triggering characteristics for triggering application of the policy to electronic content.

17. The computer program product of claim 11, wherein modifying the electronic content to mask instances of the set of identifiable elements in the electronic content comprises:
retrieving element models corresponding to the different types; and
modifying the electronic content based on the retrieved element models, wherein the element models map identifiable elements of a corresponding type to at least one of an alternative element of the same type or a masking algorithm for modifying data representing identifiable elements of the corresponding type.

18. The computer program product of claim 17, wherein modifying the electronic content to mask instances of the set of identifiable elements in the electronic content comprises identifying instances of the identifiable elements in the electronic content based on one or more identification algorithms specified in the element models.

19. The computer program product of claim 11, wherein the electronic content comprises a digital image, and wherein the instances of identifiable elements comprise at least one of persons, objects, or text depicted in portions of the digital image.

20. An apparatus comprising:
a processor; and
a memory coupled to the processor, wherein the memory comprises instructions which, when executed by the processor, cause the processor to implement a policy based content masking engine that operates to:
obtain electronic content comprising instances of identifiable elements of different types capable of uniquely identifying a person;
retrieve a policy in response to obtaining the electronic content, wherein the policy specifies a set of identifiable elements of different types to be masked in the electronic content;
modify, responsive to the retrieved policy, the electronic content to mask instances of the set of identifiable elements in the electronic content, wherein modifying the electronic content comprises applying different masking actions to the different types of identifiable elements in the set of identifiable elements; and
output the modified electronic content, wherein the modified electronic content comprises obscured or replaced instances of the identifiable elements in the set of identifiable elements.
